(19) United States
(12) Patent Application Publication
(10) Pub. No.: US 2014/0265297 A1
(43) Pub. Date: Sep. 18, 2014

(54) Writing tab for clipping to a substrate providing firm flat writing surface

(71) Applicant: Steven M. Schofield, New York, NY (US)

(72) Inventor: Steven M. Schofield, New York, NY (US)

(21) Appl. No.: 13/999,443

(22) Filed: Feb. 26, 2014

Related U.S. Application Data
(60) Provisional application No. 61/777,150, filed on Mar. 12, 2013.

(51) Int. Cl. B43L 3/00

(52) U.S. Cl. CPC B43L 3/00
USPC 281/45

(57) ABSTRACT

A unitary writing tab for clipping to a substrate comprising a top writing surface, an opposed bottom layer and a flat, firm, leveling shelf secured against and between the top writing surface and the bottom layer. A clip is fixedly secured against and between the flat leveling shelf and the bottom layer and configured such that the writing tab can be clipped to a substrate. The writing tab provides an efficient and inexpensive means for inscribing information on documents or other materials clipped thereto.

### RELATED APPLICATION

This application claims the benefit of U.S. Provisional Application No. 61/777,150, filed 12 Mar. 2013.

### BACKGROUND OF THE INVENTION

Clips for fastening papers are well known and generally consist of a rod-like wire or plastic material formed into overlaying biased U-shaped loops, or fanciful shapes having overlaying biased extensions, between which the edges of documents are placed such that the bias forces between the U-shaped loops or extensions hold the documents together. Many efforts have been undertaken over the years to enhance efficiencies of standard clips, such as by adding extensions to paper clips that secure marking papers or tab-like protrusions to provide for color coding of groups of paper or to provide a writing surface connected to the paper clip for adding identifying information to groups of papers, cataloging, etc. For example, U.S. Pat. No. 7,857,127 that issued to Lau on Dec. 28, 2010 includes over ninety pages of drawings of various forms of clips that use a spring-bias binding force to secure a writing surface to a label to be affixed by the binding force of a clip to a paper or groups of papers. Embodiments shown at 47-50 of Lau show an embodiment that is generally available in the marketplace at such well known distributors as “STAPLES” retail and on-line stores under a trademark of “KEY NOTES”. Such clips with writing surfaces unfortunately however have flexible, thin paper writing surfaces that are not sufficiently rigid for convenient, efficient writing. Moreover the writing surfaces extend away from the clip portion, thereby making a perimeter of the clipped papers irregular and difficult to insert into envelopes or files without risk of the writing surface of the clip being removed or damaged.

In the many years since the traditional three-loop paper clip's inception, attempts have been made to increase its functionality so that it's not only a fastening device, but a device also capable of being written upon. For if a paper clip also possessed a writing area it would eliminate the need for separate memo paper for note-taking as the memo paper would now be “built-in” to the paper clip itself. Prior efforts to create such an efficient device combining both of these features have led to several assemblies that have tried to attach writing areas to paper clips.

The problem with these prior assemblies however, is that they are indicated for filing and categorization because the writing areas extend out unsupported beyond the paper clip and the fastened materials to serve only as index tabs. While an unsupported index tab jutting out from a document may or may not be acceptable for recording filing or categorizing information, it is a completely unusable format for recording sensitive information meant to be contained within the borders of a document and kept private, for example information such as monetary totals, private memos, critical remarks, disposable info or any notation unintended for categorization.

Furthermore, if a prior art assembly is attached to a document that rests upon a cluttered desk or is simply being held by someone who needs to record data upon the assembly they must place it flat on a clean hard area for writing. This is because the prior assemblies avoid using the body of the paper clip to support their writing area. In fact, the body of the paper clip is avoided so thoroughly in the prior art that the extensions of the paper clip are left exposed right next to the writing area, which creates another problem for the writer. This problem is that the writer must avoid the exposed paper clip when writing as it is directly in the path of the writer's writing hand. None of the prior art attempts to fix such an obstacle to the writing process.

Further examples of efforts to produce an efficient clip include U.S. Pat. No. 1,897,755 that discloses a non-disposable rectangular spring for clasping papers. The spring folds in half, much like a money clip and is wrapped entirely in durable materials that allow marking and erasing upon its pre-printed template. Although possibly only one side of the device has a template for marking, its design requires that all four sides are thoroughly wrapped so that the spring is hidden from sight. This represents an extravagance of materials that not only contributes significantly to its overall cost, but also reinforces its cumbersome need to be reused. Additionally, the bulk of the clip is doubled when each wrapped arm is closed for fastening to materials. The doubled bulk makes it much more difficult to store numerous devices or to dispose of in paper shredders and also makes it inordinately heavy for attaching to small receipts or single page documents. U.S. Pat. No. 6,363,582 reveals a hollowed nameplate device that loosely hangs from a similarly-shaped hooked pin inserted into its shaft. Within the shaft, the pin bobbles unsecured and is attached only by a hook at its end caught in a bended area. Such a configuration permits both the pin and nameplate to move independently of each other whenever either or both are touched. While such a design works, as indicated, when the device hangs from a lapel pocket, it is of no use when placed horizontally or flat atop a desk where the pin could sway and the vertical locking mechanism would alternately engage and slacken. Additionally, the presence of a shaft cut wider and deeper than the pin would increase the overall thickness and width of the device and contribute to it having a greater bulk. U.S. Pat. No. 5,398,384 discloses a nearly solid rectangular fastener made of resin. Flexible tabs are cut-into the fastener's borders for attachment to materials. Its acrylic design prevents its manufacture from capitalizing on the ubiquitous, common design of the traditional paper clip. This specialized construction makes it more of a permanent device rather than an efficient or disposable clip. The acrylic material similarly makes it difficult to store many devices or to dispose of the device in paper shredders.

U.S. Pat. No. 7,509,765 and U.S. Pat. No. 4,951,408 also disclose paper-fastening devices with an informative element that retains the efficient fastening ability of a traditional paper clip. However, neither has a writing surface or informative area that exists over the body of the paper clip or over the fastened document itself. The informative areas are completely unsupported beneath a writing surface. Neither is designed for information that is not meant to be categorized.

U.S. Pat. No. 7,509,765 reveals a device that is essentially a traditional paper clip with a flag-like label attached to an extension of the clip's wire. Since the flag-like label is free-standing any writing done upon it will be difficult if it rests upon a cluttered desk or some such uneven surface or no surface at all. This clip also extends beyond a perimeter of the clipped papers.

U.S. Pat. No. 4,951,408, discloses a device that is not intended for immediate notation. It hinges a transparent cover on the end of a traditional paper clip for use with colored tabs that are inserted into it to categorize and improve filing methods. No supported writing surface is provided.

U.S. Pat. No. 2,186,508 and U.S. Pat. No. 5,870,802 disclose non-inscribable paper-fastening devices that use traditional paper clips for promotional advertising purposes. U.S. Pat. No. 2,186,508 shows a paper clip device intended to display pre-printed advertising upon a thin paddle-shaped overlay. The overlay's advertising area is limited to being a tiny size by a prong construction that exposes segments of the clip. The exposed segments prevent the advertising area from extending beyond the paper clip's borders. The advertising area is additionally limited in size by the sides of the overlay which cannot extend beyond the lateral sides of the paper clip. These sides attach directly to the upside of the paper clip, but not its underside or anything else. Such a delicate application makes attaching the overlay to the paper clip, difficult and tenuous.

U.S. Pat. No. 5,870,802 also discloses a device that displays pre-printed promotional advertisements upon material that is wrapped around a traditional paper clip so completely that it renders the paper clip unrecognizable. The device, having no solid surface area upon which to write may also become crushed, harmed or have its promotional material removed in some way when pressed with a writing implement in an attempt at notation because the material is adhered to the clip with nothing more than its own tenuous and inserted folds. It is for these reasons the device is best used for its intended purpose as a fastener that displays advertisements instead of a fastener for adding any information by the user of the fastener. Additionally, the material bearing the promotional indicia may become crushed if packed tightly in boxes during shipping.

Consequently, there is a need for an efficient and inexpensive clip with a writing layer tightly secured against an extension of the clip so as to provide a writing surface that is free from physical interference and unsecured movement from the clip while it is being used for writing, and that can also be used for binding a document or substrate.

### SUMMARY OF THE INVENTION

The present invention is a unitary writing tab for clipping to a substrate and providing a flat, firm, level writing surface, which comprises a top writing surface, an opposed bottom layer and a flat leveling shelf fixedly secured against and between the top writing surface and the bottom layer of the writing tab and configured to form a support for the writing surface; and a clip including at least an exterior extension defining a first plane, at least an interior extension defining a second plane disposed about parallel to and about overlying the first plane, and the exterior extension being connected to the interior extension through a bias segment passing between a perimeter of the exterior extension and a perimeter of the interior extension; the interior extension of said clip being fixedly secured against and between the flat leveling shelf and the bottom layer so that the exterior extension is secured adjacent an outside surface of the bottom layer, and so that the bias segment applies a bias forcing the exterior and interior extensions toward each other when said writing tab is applied to a substrate or removed therefrom.

Preferably, the flat leveling shelf is configured so that the writing surface can be employed for writing without interference from the clip. To this end, the flat leveling shelf comprises a plurality of layers of sheet-like material adhered to each other, or may comprise one layer of a firm material, which is adequately thick and firm such that the rod elements of the clip do not interfere with a user's ability to write smoothly on the tab's top surface. Most preferably, the top writing surface, flat leveling shelf, bottom layer and clip are adhesively bound together such that there is essentially no movement of any of the layers comprising the tab relative to each other, nor of the clip in any direction relative to the tab layers other than that required to open the clip to attach it to a substrate or remove it therefrom.

A preferred embodiment of the present invention comprises a writing tab with an integral traditional paper clip for clipping to a substrate which provides a firm, level writing surface on the writing tab and over the paper clip thereof. Such a writing tab comprises a top writing surface, a bottom layer opposed to the top writing surface, and a flat leveling shelf fixedly secured against and between the top writing surface and the bottom layer of the writing tab and configured to form a flat, firm support for the writing surface; and a paper clip including a rod extending away from a starting end a first straight distance to form a first U-shaped loop, the rod extending back toward and beyond the starting end a second straight distance greater than the first straight distance to form a second U-shaped loop, the rod extending back toward and beyond the starting end a third straight distance that is less than the second straight distance, and the rod forming a third U-shaped loop within the first U-shaped loop between the starting end, the first U-shaped loop and a finishing end of the rod; one of the first U-shaped loop and the third U-shaped loop of the paper clip being fixedly secured against and between the flat leveling shelf and the bottom layer so that the one of the first U-shaped loop and the third U-shaped loop is secured adjacent an outside surface of the bottom layer and the other of the first U-shaped loop and the third U-shaped loop is secured within the writing tab, between the flat leveling shelf and the bottom layer, and the second U-shaped loop is outside of and adjacent to the writing surface.

Preferably, in this embodiment with a traditional three-loop paper clip, the flat leveling shelf is configured so that the writing surface can be employed for writing without interference from the clip. To this end, the flat leveling shelf comprises a plurality of layers of sheet-like material adhered to each other, or may comprise one layer of a firm material, which is adequately thick and firm such that the elements of the clip do not interfere with a user's ability to write smoothly on the tab's top surface. Most preferably, the top writing surface, flat leveling shelf, bottom layer and clip are adhesively bound together such that there is essentially no movement of any of the layers comprising the tab relative to each other, nor of the clip in any direction relative to the tab layers other than that required to open the clip to attach it to a substrate or remove it therefrom.

### BRIEF DESCRIPTION OF THE DRAWINGS

FIG. 1 is a top plan view of a standard, three-loop paper clip.

FIG. 2 is a top plan view of a fanciful, “Penguin-shaped” clip having an interior and an exterior extension.

FIG. 3 is a bottom plan view of a unitary writing tab of the present invention employing a traditional three-loop paper clip.

FIG. 4 is a top perspective view of the FIG. 3 writing tab showing a traditional three-loop paper clip fixedly secured against and between the flat leveling shelf and the bottom layer.

FIG. 5 is a side view of the writing tab of FIG. 4 FIG. 6 is a bottom perspective view of the FIG. 4 writing tab with the writing tab rotated 180 degrees to show a U-shaped loop of the paper clip secured adjacent an outside surface of a bottom layer of the writing tab. FIGS. 3-6 are not drawn to scale and the thickness of the writing tab as depicted is exaggerated to illustrate the component layers and the positioning of the paper clip therein.

### DETAILED DESCRIPTION OF THE INVENTION

The present invention is a unitary writing tab for clipping to a substrate and providing a flat, firm, level writing surface, which comprises a top writing surface, an opposed bottom layer and a flat leveling shelf fixedly secured against and between the top writing surface and the bottom layer of the writing tab and configured to form a support for the writing surface, with one loop or extension of a paper clip being fixedly secured against and between the flat leveling shelf and the bottom layer and another loop or extension of the paper clip being adjacent to the outside surface of the bottom layer and configured such that the writing tab can be clipped to a substrate.

In an embodiment of the invention utilizing a traditional paper clip, the paper clip includes a rod extending away from a starting end a first straight distance to form a first U-shaped loop, and the rod extends back toward and beyond the starting end a second straight distance that is greater than the first straight distance to form a second U-shaped loop. The rod then extends back toward and beyond the starting end of the rod a third straight distance that is less than the second straight distance. The rod then forms a third U-shaped loop within the first U-shaped loop between the starting end of the rod, the first U-shaped loop and a finishing end of the rod. Each of the three loops define planes that are disposed about parallel to each other and the plane defined by the third loop overlies the planes defined by the first and second loops whenever a portion of paper or a similar substrate is secured between the first and third loops. The clip also includes a bias segment of the rod passing between the second loop and the third loop that applies a bias forcing the planes defined by the first and third loops toward each other whenever a substrate is secured between the first and third loops. Many non-traditional clips, such as fanciful animal-shaped clips for securing papers together, are increasingly common and are defined herein as a clip having an exterior extension defining a first plane, and an interior extension defining a second plane disposed about parallel to the first plane. The exterior extension is connected to the interior extension through a bias segment passing between a perimeter of the exterior extension and a perimeter of the interior extension so that the first plane and the second plane overlie each other, and so that the bias segment applies a bias forcing the extensions toward each other whenever a paper or similar substrate is secured between the interior and the exterior extensions.

The unitary writing tab also includes a top writing surface and a bottom layer opposed to the top writing surface. A flat leveling shelf is fixedly secured against and between the top writing surface and the bottom layer of the tab. As further described below, the flat leveling shelf is a layer or layers of material configured to form a flat, firm, level support for the writing surface. As more fully described later, one loop or interior extension of a paper clip of the types described above is fixedly secured against and between the flat leveling shelf and the bottom layer and another loop or exterior extension of the paper clip is disposed outside and adjacent to the outside surface of the bottom layer. Documents or other substrates can be inserted between the latter outside loop or exterior extension and the adjacent outside surface of the bottom layer, such that the writing tab is clipped to the substrate and desired information can be written on the top writing surface

The writing surface can be made of any inscribable material, but is preferred to be of a kind that serves as an exemplary material for use in writing, such as writing paper, label paper or label stock, customized or generic stationery, cardboard, card stock, plastic, vinyl, cloth, metal, Mylar, vellum, or notecards. The overall thickness of the writing surface can vary based on the chosen material, but should contribute toward an objective of creating as flat and firm a writing tab as can be created. For the traditional, three-loop paper clip, the flat leveling shelf effectively covers the part of the paper clip that is always left exposed in prior art note clips. For the two-extension clip, the flat leveling shelf covers the exterior extension. As described above, when the rods of the paper clip are left exposed adjacent the writing area as in the prior art, they present obstacles one must avoid in the writing path on a tab on the clip. The present flat leveling shelf may be a plurality of layers of paper-like materials of sufficient thickness to produce a flat, firm, level support for the writing surface, or the flat leveling shelf may include a rigid or semi-rigid material, such as plastic, to support the writing surface. In one specific embodiment of a writing tab comprising a traditional three-loop paper clip of stainless steel with a common wire diameter of approximately 1.2 mm, the flat leveling shelf could be made of a kind of plastic sheet, for example PET or a similar polymeric material, that has a thickness of approximately 0.5 mm. to be sufficient to create a functioning firm, flat, level, even writing surface over and against certain bumpy ridges and hollow spaces of the paper clip. This does not, however, limit the flat leveling shelf or the clip to being only these specifications, as the flat leveling shelf and clip could also be made of different materials, shapes and measurements as deemed most appropriate for the desired use.

Additionally, the first U-shaped loop or the exterior extension being secured adjacent the bottom layer provides a stronger base for the writing surface than any prior art note clip.

The bottom layer is preferably a thin, pliable layer of material such that it can be laid flat and affixed across much of the bottom-facing surface of the flat leveling shelf while also being secured flatly against the clip. It can be created from various types of paper, label stock, plastic or any suitable material available in sheet form. Additionally, the outside surface of this bottom layer should have a texture that allows for any document or substrate being clipped or released by the writing tab to glide easily across it. As stated elsewhere, the area of the bottom layer is preferred to be essentially co-extensive with that of the flat leveling shelf, but may also be smaller than the flat leveling shelf.

A preferred embodiment of the writing tab is configured so that the peripheries of the flat leveling shelf, writing surface and bottom layer are such distances from the interior extension and exterior extension that they do not in any way present an obstacle to any document or substrate being inserted between the outside surface of the bottom layer and the exterior extension. Such an embodiment with a border of extended peripheries may benefit a person who is attaching a document or substrate to a writing tab because the peripheries could be used as a guide to negotiate the document or substrate across the expanse of the bottom layer to the more specific destination between the exterior extension and the outside surface of the bottom layer where the document or substrate would then be attached to the writing tab.

It is pointed out that the phrases “interior extension” and “exterior extension” as they apply to the two-extension clip refer only to the particular extensions as they are secured to the writing tab. In other words, the “interior extension” refers to one of the two extensions that is secured against and between the flat leveling shelf and the bottom layer of the writing tab, and the “exterior extension” refers to one of the two extensions that is secured adjacent the outside surface of the bottom layer of the writing tab. Additionally, the “interior extension” may be larger or smaller than the “exterior extension”, and the phrases are not meant as limitations on relative dimensions of the extensions.

The second U-shaped loop of the three-loop paper clip may be outside of the periphery of the writing surface of the tab and may also extend away therefrom to facilitate holding and manipulation of the writing tab. In a preferred embodiment, the writing tab is configured to be of an adequate size so that neither the first nor the third loop of the traditional three-loop paper clip, or that neither the exterior extension nor the interior extension of a fanciful paper clip extends beyond the periphery of the writing surface.

A user can employ the present writing tab to organize a variety of different sized papers, such as travel receipts, credit card statements, household bills, etc. As further described in more detail below, perimeter edges of a group of documents or another substrate would be placed between the outside surface of the bottom layer and the loop or extension of the paper clip outside of and adjacent thereto. Prior to or after attachment of the writing tab to the stack of receipts, the user can inscribe on the writing surface of the writing tab the desired information, such as monetary totals, the date of the trip, and perhaps the initials of the business person that incurred the receipts, etc. Another major advantage of the present writing tab is that the writing surface will be adjacent or below a top edge of the document to which the writing tab is secured. Unlike known prior art clip tabs used primarily for identifying groups of documents or a document, the present writing tab provides for the information on the clip (such as monetary totals, etc.) being below a top edge of the document to which the writing tab is secured so that the information may remain relatively private, and unseen in filing such groups of clipped documents. This provides for easy storage, such as in a file or business envelope, with virtually no risk that the writing tab or the clip thereof will be detached from the group of bound documents.

The manufacture of the writing tab is achieved by simply securing the bottom layer over the flat leveling shelf by application of an adhesive to the bottom layer and/or the adjacent surface of the flat leveling shelf, then sliding the bottom layer between the first U-shaped loop and third U-shaped loop of the three-loop paper clip, or between the interior and exterior extensions, and then securing one of the first U-shaped loop and the third U-shaped loop, or the interior extension, between the flat leveling shelf and the bottom layer. In one embodiment, a one-sided adhesive tape can be utilized as the bottom layer, the adhesive side bonding the clip to the bottom-facing surface of the flat leveling shelf. The dimensions of the writing surface and underlying flat leveling shelf and bottom layer may vary in different embodiments, but are generally co-extensive. In one embodiment the dimensions of an adequate writing surface and flat leveling shelf may be smaller than the total area of the clip to provide for a minimal amount of information in cataloging groups of documents, and for providing a lot of writing tabs in small retail-sales containers. In other embodiments, the dimensions of the writing surface and flat leveling shelf may be substantially larger than the clip to provide a greater writing surface to hold more information.

In a business office or home office setting, an advantageous embodiment may have approximate dimensions similar to those of a popular size of 3M Post-it® brand notes, that being approximate dimensions of three inches by three inches. This does not, however, limit the flat leveling shelf or writing surface to being only this approximate size or to being quadrilaterals, as they could also be shaped to resemble circles, triangles, composite shapes, familiar shapes or random shapes as deemed most appropriate for the desired use.

Referring to the drawings in detail, a unitary writing tab of the present invention is shown in FIGS. 3-6 and is generally designated by reference numeral 10. FIG. 1 shows a traditional three-loop paper clip 12. The clip 12 includes a rod 14 that extends away from a starting end 16 of the rod 14 a first straight distance 18 to form a first U-shaped loop 20. The rod 14 then extends back toward and beyond the starting end 16 a second straight distance 22 that is greater than the first straight distance 18 to form a second U-shaped loop 24. The rod 14 extends from the second loop 24 back toward and beyond the starting end 16 of the rod 14 a third straight distance 26 that is less than the second straight distance 22. The rod 14 then forms a third U-shaped loop 28 within the first U-shaped loop 20 between the starting end 16 of the rod 14, the first U-shaped loop 20 and along a fourth straight distance 29 to a finishing end 30 of the rod 14. The three-loop paper clip 12 also includes a bias segment 19 of the rod passing between the second loop 24 and the third loop 28 that applies a bias forcing the planes defined by the first loop 20 and third loops 28 toward each other whenever a portion of paper (not shown) is secured between the first loop 20 and third loop 28.

While the standard paper clip 12 is appropriate for most embodiments of the writing tab 10 it is to be understood that any clip that includes at least two extensions, wherein one extension asserts a spring-bias force against the other extension when the extensions are separated so that the extensions assert a force to bind documents (not shown) together, may also be used with the writing tab 10. FIG. 2 shows an exemplary two-extension clip in the form of a fanciful “Penguin-shaped” clip 21 having an exterior extension 23 defining a first plane (not shown in the drawings), and an interior extension 25 defining a second plane (not shown in the drawings) disposed about parallel to the first plane. The exterior extension 23 is connected to the interior extension through a bias segment 27 passing between a perimeter 29 of the exterior extension 23 and a perimeter 31 of the interior extension 25. The bias segment 27 and two extensions 23, 25 are disposed so that the planes defined by the exterior and interior extensions 23, 25 overlie each other, and so that the bias segment 27 applies a bias forcing the exterior and interior extensions 23, 25 toward each other whenever a paper (not shown) or similar substrate is secured between the exterior extension 23 and the interior extension 25. The bias segments 19, 27 may simply be a portion of a rod-like material making up the three loops 20, 24, 28 or the two extensions 23, 25, wherein the material, such as a metal or plastic substance, has adequate torsional strength to resist twisting or rotational movement and thereby apply a bias force to the overlying first and third loops 20, 28 or the overlying interior and exterior extensions 23, 25. Additionally, the bias segments 19, 27 may be any other structure that can be secured between the first and third loops 20, 28 or the interior and exterior extensions 23, 25 that can perform the described function.

FIG. 3 is a bottom plan view showing the paper clip 12 of FIG. 1 employed in a writing tab of the present invention. The paper clip 12 is fixedly secured against and between the flat leveling shelf 44 and the bottom layer 42 so that the first U-shaped loop 20 is adjacent an outside surface 34 of the writing tab 10. The second U-shaped loop 24 is shown in FIG. 3 so extending and the third U-shaped loop 28 is shown in hatched lines fixedly secured against and between the flat leveling shelf 44 and the bottom layer 42 of the writing tab 10. Alternatively, the first U-shaped loop 20 may be the one fixedly secured against and between the flat leveling shelf 44 and the bottom layer 42. As best shown in FIGS. 4, 5 and 6, the writing tab 10 includes a top writing surface 40 and a bottom layer 42 opposed to the top writing surface 40. A flat leveling shelf 44 is fixedly secured against and between the top writing surface 40 and the bottom layer 42 of the writing tab 10. The flat leveling shelf 44 is configured to form a flat, firm, level support for the writing surface 40. As described above, the flat leveling shelf 44 may be a plurality of layers (not shown) of paper-like materials of sufficient thickness to produce a firm, level support for the writing surface 40, or the flat leveling shelf 44 may include a rigid or semi-rigid material (not shown), such as plastic, to support the writing surface 40. The bottom layer 42 and flat leveling shelf 44 are both permanently affixed to one of the first U-shaped loop 20 and the third U-shaped loop 28 to form a seal upon and around the third U-shaped loop 28 so that it is secure and immovable in any direction. As further shown in FIGS. 4, 5 and 6, the writing tab is configured to permanently secure the third U-shaped loop 28 of the paper clip 12 between the surface of the bottom layer 42 and the flat leveling shelf 44 so that the first U-shaped loop 20 is secured adjacent the outside surface 34 of the bottom layer 42. The writing tab is also configured so that the second U-shaped loop 24 is outside of and extends away from the periphery of the writing surface. However, it is to be understood that the writing tab may also be configured so that the second U-shaped loop 24 is flush with a periphery of the writing surface and does not extend away therefrom for circumstances when it is desired to have the writing tab 10 be flush with documents (not shown) secured between the first loop 20 and the outside surface 34 of the bottom layer 42.

As noted previously, in use of the writing tab 10 of the present invention comprised of a traditional paper clip, the perimeter edge of a document of one or more pages or another substrate (not shown) would be placed between the first U-shaped loop 20 and the adjacent outside surface 34 of the bottom layer 42. Similarly, when using a writing tab comprised of a fanciful paper clip such as clip 21, the perimeter edge of the substrate would be placed between the exterior extension 23 and the adjacent outside surface 34 of the bottom layer 42. In this way, the writing tab is clipped to the substrate and desired information can be written on the top writing surface.

As described above, the phrases “interior extension 25” and “exterior extension 23” as they apply to the two-extension clip 21 refer only to the particular extensions 25, 23 as they are secured between the flat leveling shelf 44 and the bottom layer 42. In other words, the interior extension 25 refers to one of the two extensions 25, 23 that is secured between the flat leveling shelf 44 and the bottom layer 42, and the exterior extension 23 refers to one of the two extensions 25, 23 that is secured adjacent the outside surface 34 of the bottom layer 42 of the writing tab 10. Additionally, the interior extension 25 may be larger or smaller than the exterior extension 23, and these phrases are not meant as limitations on relative dimensions of the extensions. Also, many of the fanciful-shaped clips, such as the Penguin-shaped clip 21, include more than two extensions that may be utilized in securing the clip to bundle of papers. Therefore, this disclosure also refers to the extensions as “at least an exterior extension 23 and an interior extension 25” to embrace such multi-extension clips (not shown).

In use of the writing tab 10, perimeter edges of a group of documents or another substrate (not shown) would be placed between the first U-shaped loop 20 and the outside surface 34 of the bottom layer 42, or between the exterior extension 23 and the outside surface 34. The bias segment 19 would then apply a spring-bias force to secure the documents to the writing tab 10. A user (not shown) could then inscribe identifying information on the writing surface 40 of the writing tab 10. The user could also inscribe such information prior to attaching the documents to the writing tab 10.

For purposes herein, the word “about” is to mean plus or minus ten percent.

While the present invention has been presented above with respect to the described and illustrated embodiments of the writing tab 10 including a three-loop traditional paper clip 12 or fanciful two-extension clip 21, it is to be understood that the disclosure is not to be limited to those alternatives and described embodiments. Reference should be made to the following claims to determine the scope of the invention.

What is claimed is:

1. A unitary writing tab for clipping to a substrate and providing a firm, level writing surface, the writing tab comprising:
(a). a top writing surface, an opposed bottom layer and a flat leveling shelf fixedly secured against and between the top writing surface and the bottom layer of the writing tab and configured to form a support for the writing surface; and
(b). a clip including at least an exterior extension defining a first plane, at least an interior extension defining a second plane disposed about parallel to and about overlying the first plane, and the exterior extension being connected to the interior extension through a bias segment passing between a perimeter of the exterior extension and a perimeter of the interior extension; the interior extension of said clip being fixedly secured against and between the flat leveling shelf and the bottom layer so that the exterior extension is secured adjacent an outside surface of the bottom layer, and so that the bias segment applies a bias forcing the exterior and interior extensions toward each other when said writing tab is applied to a substrate.

2. The writing tab of claim 1 wherein the flat leveling shelf is configured so that the writing surface can be employed for writing without interference from the clip.

3. The writing tab of claim 1, wherein the flat leveling shelf comprises a plurality of layers of sheet-like material adhered to each other.

4. The writing tab of claim 1, wherein the flat leveling shelf comprises one layer of a firm material.

5. The writing tab of claim 1 wherein the writing surface, flat leveling shelf, bottom layer and clip are adhesively bound together.

6. A unitary writing tab for clipping to a substrate and providing a firm, level writing surface, the writing tab comprising:
(a) a top writing surface, a bottom layer opposed to the top writing surface, and a flat leveling shelf fixedly secured against and between the top writing surface and the bottom layer of the writing tab and configured to form a firm support for the writing surface; and
(b). a paper clip including a rod extending away from a starting end a first straight distance to form a first U-shaped loop, the rod extending back toward and beyond the starting end a second straight distance greater than the first straight distance to form a second U-shaped loop, the rod extending back toward and beyond the starting end a third straight distance that is less than the second straight distance, and the rod forming a third U-shaped loop within the first U-shaped loop between the starting end, the first U-shaped loop and a finishing end of the rod; one of the first U-shaped loop and the third U-shaped loop of the paper clip being fixedly secured against and between the flat leveling shelf and the bottom layer so that the one of the first U-shaped loop and the third U-shaped loop is secured adjacent an outside surface of the bottom layer and the other of the first U-shaped loop and the third U-shaped loop is secured within the writing tab, and the second U-shaped loop is outside of and adjacent to the writing surface.

7. The writing tab of claim 6 wherein the flat leveling shelf is configured so that the writing surface can be employed for writing without interference from the clip.

8. The writing tab of claim 6, wherein the flat leveling shelf comprises a plurality of layers of sheet-like material adhered to each other.

9. The writing tab of claim 6, wherein the flat leveling shelf comprises one layer of a firm material.

10. The writing tab of claim 6 wherein the writing surface, flat leveling shelf, bottom layer and paper clip are adhesively bound together.
